(19) United States
(12) Patent Application Publication
(10) Pub. No.: US 2016/0012070 A1
(43) Pub. Date: Jan. 14, 2016

(54) METHODS FOR MANAGING A REQUEST TO LIST PREVIOUS VERSIONS OF AN OBJECT AND DEVICES THEREOF

(71) Applicant: NetApp, Inc., Sunnyvale, CA (US)

(72) Inventors: Amit Aggarwal, Mathura (IN); Ajeet Kumar, Bangalore (IN)

(21) Appl. No.: 14/325,818

(22) Filed: Jul. 8, 2014

(51) Int. Cl. G06F 17/30

(52) U.S. Cl. CPC G06F 17/30088; G06F 17/30339; G06F 17/30174

(57) ABSTRACT

A method, non-transitory computer readable medium, and device that manages requests to list previous versions of an object includes receiving a previous version listing request including an object path for an object. The presence of the junction point within the received previous version listing request is determined. The junction point is resolved to identify a snapshot directory when the received previous version listing request is determined to include the junction point. A plurality of object entries present within the identified snapshot directory is provided as previous versions of the object to a requesting client computing device.

### FIELD

This technology relates to managing a snapshot request to list previous versions of an object and devices thereof.

### BACKGROUND

The process of associating a logical unit or volume with the appropriate underlying physical media is commonly referred to in the art as mounting the logical volume on the physical media. The logical volume must be mounted before the data on the physical media can be accessed. Most of the existing storage systems support the storing of multiple versions (also known as shadow copies) of an object across different storage volumes using mounting of logical volumes. Therefore, when a client queries for previous versions of an object, existing technologies only provide the snapshots of the object within the same volume and ignores the shadow copies of the objects stored in other volumes.

### SUMMARY

A method for managing a previous version listing request to list previous version of an object includes receiving by a file system management computing device a previous version listing request including an object path for an object. The presence of the junction point within the received previous version listing request is determined by the file system management computing device. The junction point is resolved by the file system management computing device to identify a snapshot directory when the received previous version listing request is determined to include the junction point. A plurality of object entries present within the identified snapshot directory is provided by the file system management computing device as previous versions of the object to a requesting client computing device.

A non-transitory computer readable medium having stored thereon instructions for managing a previous version listing request to list previous version of an object comprising executable code which when executed by a processor, causes the processor to perform steps including receiving a previous version listing request including an object path for an object. The presence of the junction point within the received previous version listing request is determined. The junction point is resolved to identify a snapshot directory when the received previous version listing is determined to include the junction point. A plurality of object entries present within the identified snapshot directory is provided as previous versions of the object to a requesting client computing device.

A file system management computing device includes a memory coupled to a processor configured to execute programmed instructions stored in the memory including receiving a previous version listing request including an object path for an object. The presence of the junction point within the received previous version listing is determined. The junction point is resolved to identify a snapshot directory when the received previous version listing request is determined to include the junction point. A plurality of object entries present within the identified snapshot directory is provided as previous versions of the object to a requesting client computing device.

This technology provides a number of advantages including providing methods, non-transitory computer readable medium and devices for managing a snapshot request to list previous versions of an object. This technology easily manages to process junction or mount point components within a received path to provide snapshots and timestamps of all the shadow objects. By way of example only, if there is an object X stored in first volume having time stamps t1, t2, t3 and if the first volume also has a junction point to second volume which includes shadow copies of the object X with time stamps t4, t5, t6; the technology disclosed here provides the time stamps (t4, t5 and t6) for the shadow copies of the object X in the second volume. Alternatively, the technology can also provide all the time stamps (t1, t2, t3, t4, t5 and t6) of the object X. In contrast, the existing technologies only provide the time stamps of the object X for a particular volume. For example, when there is a request for a time stamp of the object X in the first volume, existing technologies only provide time stamps of t1, t2 and t3 and completely ignores the time stamp of the shadow copies stored in second volume.

### BRIEF DESCRIPTION OF THE DRAWINGS

FIG. 1 is a block diagram of an environment with an example of a file system management computing device;

FIG. 2 is a block diagram of the exemplary file system management computing device shown in FIG. 1;

FIG. 3 is a flow chart of an example of a method for managing a snapshot request to list previous version of an object;

FIG. 4 is an example of contents of volumes with mount points; and

FIG. 5 is an example of pseudo code for managing a snapshot request to list previous version of an object.

### DETAILED DESCRIPTION

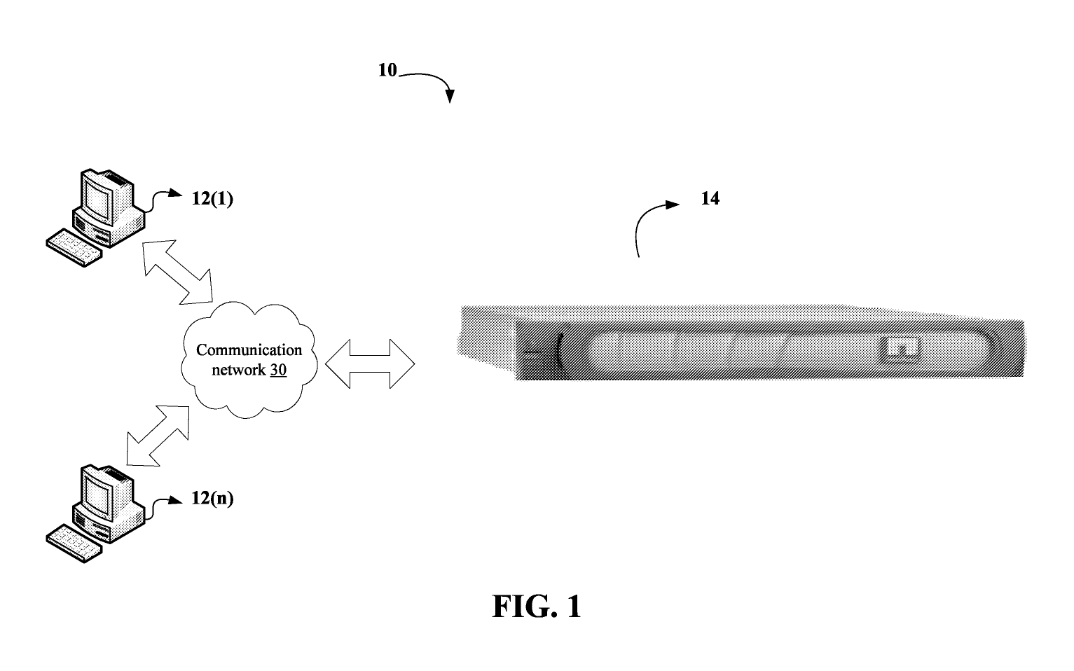

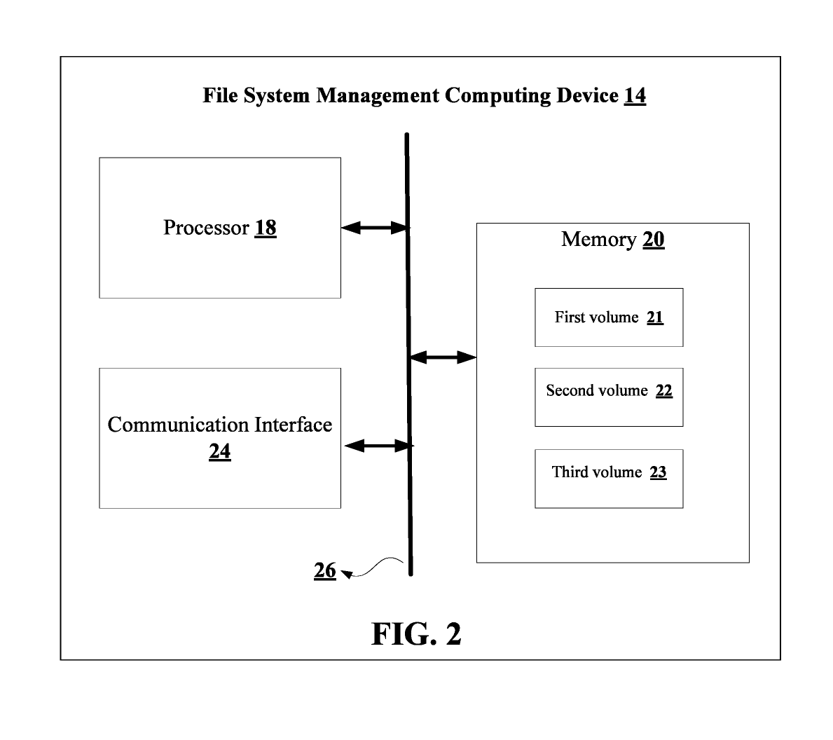

An environment 10 with a plurality of client computing devices 12(1)-12(n) and an exemplary file system management computing device 14 is illustrated in FIGS. 1-2. In this particular example, the environment 10 includes a plurality of client computing devices 12(1)-12(n) and the file system management computing device 14 coupled via one or more communication networks 30, although the environment could include other types and numbers of systems, devices, components, and/or other elements. In this example, the method for managing a snapshot request to list previous versions of an object is executed by the file system management computing device 14 although the approaches illustrated and described herein could be executed by other systems and devices. The environment 10 may include other types and numbers of other network elements and devices, as is generally known in the art and will not be illustrated or described herein. This technology provides a number of advantages including providing methods, non-transitory computer readable medium and devices for managing a snapshot request to list previous versions of an object.

Referring more specifically to FIG. 2, in this example the file system management computing device 14 includes a processor 18, a memory 20, and a communication interface 24 which are coupled together by a bus 26, although the file system management computing device 14 may include other types and numbers of elements in other configurations.

The processor 18 of the file system management computing device 14 may execute one or more programmed instructions stored in the memory 20 for replicating data and providing instantaneous access to data as illustrated and described in the examples herein, although other types and numbers of functions and/or other operation can be performed. The processor 18 of the file system management computing device 14 may include one or more central processing units (“CPUs”) or general purpose processors with one or more processing cores, such as AMD® processor(s), although other types of processor(s) could be used (e.g., Intel®).

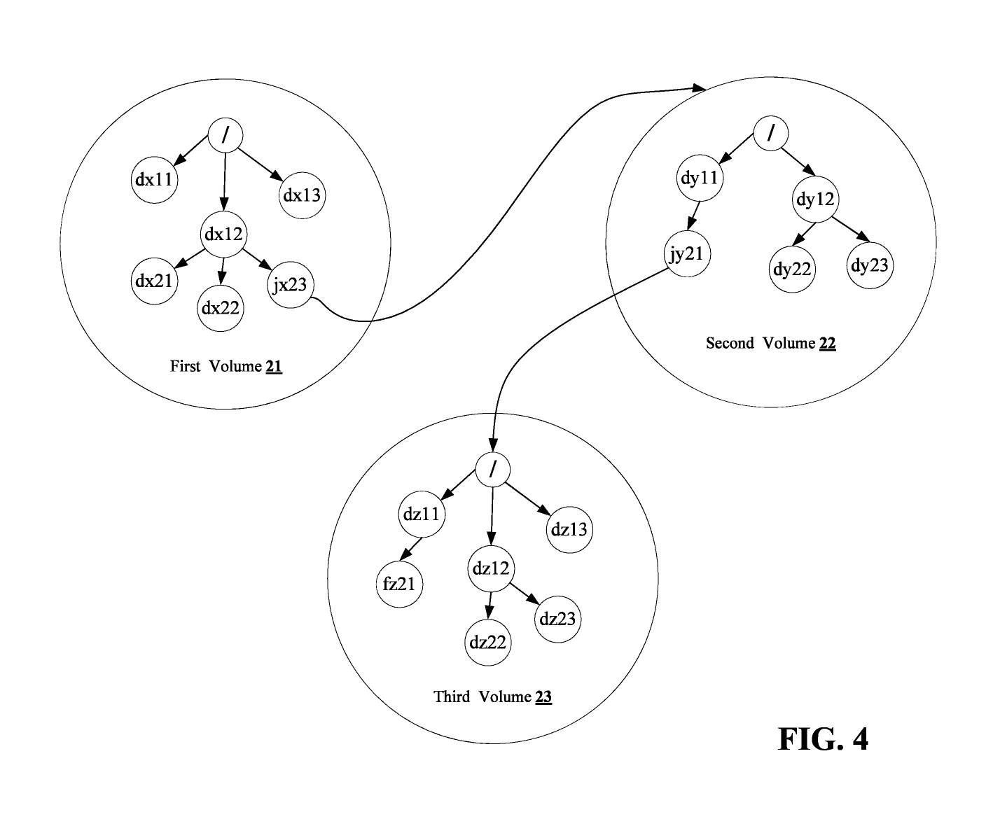

The memory 20 of the file system management computing device 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20. Additionally, as illustrated FIG. 2, the memory 20 includes a first volume 21, second volume 22 and third volume 23, although the volumes can be stored in other systems or devices in other locations. In this example, the first volume 21, second volume 22 and third volume 23 include data that can be modified, deleted, created, moved, and/or copied by the plurality of client computing devices 12(1)-12(n). In the example illustrated in FIG. 4, the first volume 21, second volume 22 and the third volume 23 includes objects, such as dx11, dy11, dz11, although the volumes within the memory 20 can include other contents, such as files and/or directories by way of example only. Additionally, the first volume 21, second volume 22 and the third volume 23 also allow mounting of one volume within the other.

The communication interface 24 of the file system management computing device 14 operatively couples and communicates with the plurality of client computing devices 12(1)-12(n), which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, an interface device, and an I/O system, which are coupled together by a bus or other link, although other numbers and types of network devices could be used. The plurality of client computing devices 12(1)-12(n) communicates with the file system management computing device 14 for requesting access to data, although the client computing devices 12(1)-12(n) can interact with the file system management computing device 14 for other purposes. By way of example, the plurality of client computing devices 12(1)-12(n) may run interface application(s) that may provide an interface to make requests to access, modify, delete, edit, read or write data within the first volume 21, second volume 22 and the third volume 23 via the communication network 30. In this example, the data within the first volume 21, second volume 22 and the third volume 23 is stored in form of data blocks, although the data can be stored in other formats.

Although the exemplary network environment 10 includes the plurality of client computing devices 12(1)-12(n) and the file system management computing device 14 described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

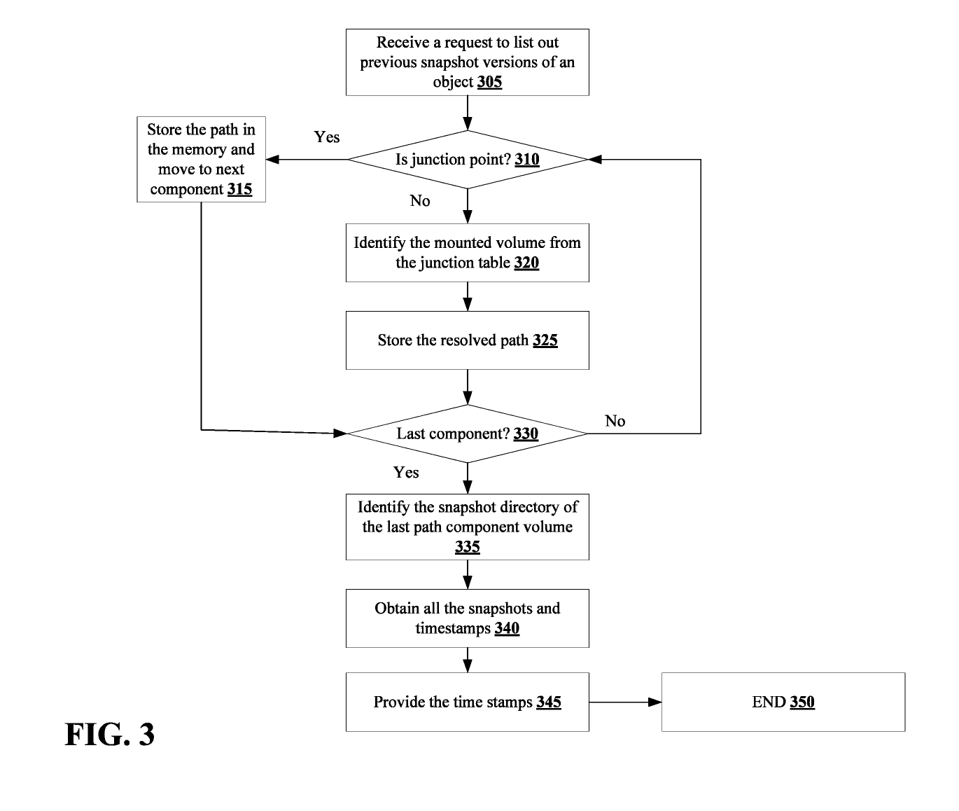

An exemplary method for managing a snapshot request to list previous version of an object will now be described with reference to FIGS. 1-5.

In step 305, the file system management computing device 14 receives a snapshot request to list out previous versions an object in a particular path stored in one of the first volume 21, second volume 22 or the third volume 23 from one of the plurality of client computing devices 12(1)-12(n), although the file system management computing device 14 can receive other types requests. By way of example only, the file system management computing device 14 can receive a FSCTL_SRV_ENUMERATE_SNAPSHOTS from the requesting one of the plurality of client computing device 12(1)-12(n) for a path type equal to /dx12/jx23/dy11/jy21/dz11/fz21. As it would be appreciated by a person having ordinary skill in the art, forward slash (/) indicates a root directory and the component after the forward slash (dx12) indicates a sub-directory or a file under the root directory.

In step 310, the file system management computing device 14 scans each component in the received path to determine if the component is a junction point. As it would be appreciate by a person having ordinary skill in the art, a junction point is a component at which there exists a link between two different volumes, or in other words, one volume is being mounted on another volume. For purpose of further illustration with reference to FIG. 4, jx23 is a junction point in the first volume 21 because the second volume 22 is mounted on the first volume 21 at jx23. Similarly, jy21 is a junction point at second volume 22 because third volume 23 is mounted on the second volume 22 at jy21.

Accordingly, if in step 310 the file system management computing device 14 determines that the component is not a junction point, then the No branch is taken to step 315. In step 315, the file system management computing device 14 stores the scanned component of the received path in the memory 20 and proceeds to step 330, although the file system management computing device 14 can store at other memory locations. By way of example only, since the first component /dxl2 of the received path /dx12/jx23/dy11/jy21/dz11/fz21 is not a junction point, the file system management computing device 14 stores the scanned component, i.e., /dxl2 in the memory 20.

If in step 310, the file system management computing device 14 determines that the scanned component is a junction point, then the Yes branch is taken to step 320. In step 320, the file system management computing device 14 resolves the junction point using information present within a junction table, although the file system management computing device 14 can resolve the junction point using other parameters or techniques. In this example, the junction table includes information regarding the junction point and the corresponding volume associated with the junction point. By way of example only, when the file system management computing device 14 scans the component /jx23 of the received path /dx12/jx23/dy11/jy21/dz11/fz21, the file system management computing device 14 determines that the component /jx23 is a junction point. Upon identifying, the file system management computing device checks the volume that is mounted at that point using the junction table, which in this example as illustrated in FIG. 4, is the second volume 22.

Next in step 325, the file system management computing device 14 stores the resolved path of the junction point within the memory 20, although the file system management computing device 14 can store at other memory locations. By way of example only, the file system management computing device 14 stores the resolved path, i.e., /dxl2/jx23 within memory 20.

In step 330, the file system management computing device 14 determines if the previously scanned component within the received path is the last component by checking if there exists a forward slash after the scanned component, although the file system management computing device 14 can determine for last component using other techniques. By way of example only, in the received path of /dx12/jx23/dy11/jy21/dz11/fz21, fz21 is the last component because there is no path component or forward slash (/) after fz21. In contrast, dy11 in the received path is not the last component because there is a forward slash or path component after dy11, i.e., /jy21/dz11/fz21.

Accordingly, if in step 330 the file system management computing device 14 determines that the scanned component is not the last component within the received path, then the No branch is taken back to step 310 to scan the next component in the received path. For example, if the last scanned component in the received path /dx12/jx23/dy11/jy21/dz11/fz21 is /dy11, the No branch is taken back to step 310 to scan the next component, i.e., /jy21.

If in step 330 the file system management computing device 14 determines that the scanned component is the last component of the received path, then the Yes branch is taken to step 335. By way of example only, if the file system management computing device 14 has scanned the component /fz21 in the received path /dx12/jx23/dy11/jy21/dz11/fz21, then the file system management computing device takes the Yes branch to step 335.

In step 335, the file system management computing device 14 identifies the snapshot directory of the last component stored within the corresponding volume, although the file system management computing device 14 can identify the snapshot directory using other parameters or techniques. By way of example only with reference to FIG. 4, the file system management computing device 14 identifies the snapshot directory for the last component fz21 of the received path /dx12/jx23/dy11/jy21/dz11/fz21 in the third volume 23 as the last component, fz21 is stored in the third volume 23. In this example, the file system management computing device 14 identifies the snapshot directory associated with the component fz21.

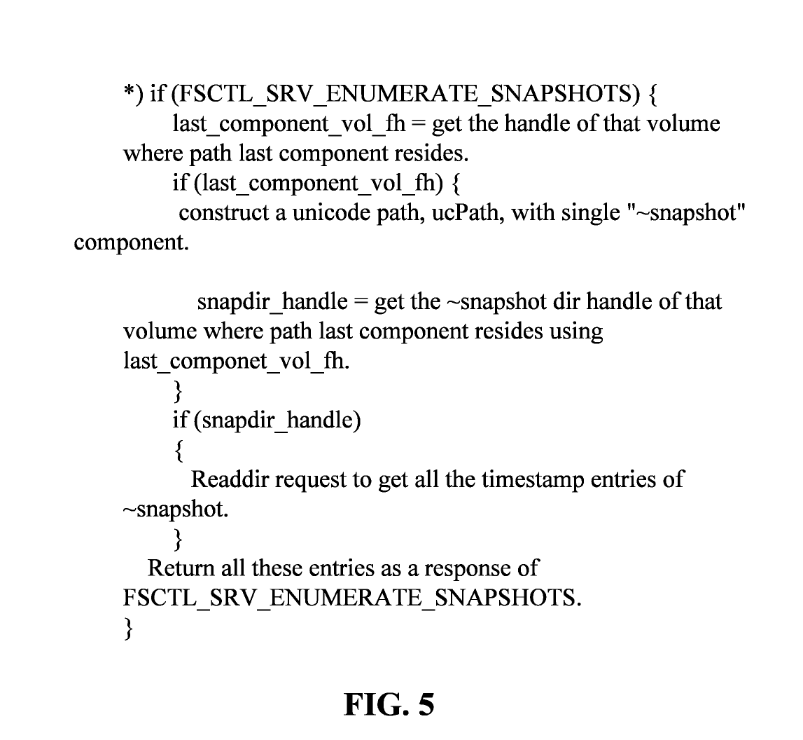

In step 340, the file system management computing device 14 obtains all the entries within the identified snapshot directory, although the file system management computing device 14 can obtain other information from the snapshot directory. In this example, the file system management computing device 14 obtains the entries using a Readdir command, although the file system management computing device 14 can use other techniques to obtain the information. The obtained entries relates to the timestamps of the objects in this example. By way of example only, FIG. 5 illustrates a pseudo code for determining the last component and also obtaining the entries in the snapshot directory.

In step 345, the file system management computing device 14 provides the obtained snapshot entries (timestamps of the objects) to the requesting one of the plurality of client computing devices 12(1)-12(n) and the exemplary method ends in step 350. In this example, the timestamps of the objects provided to the requesting one of the plurality of client computing devices 12(1)-12(n) assists with requesting one of the plurality of client computing devices 12(1)-12(n) to choose a required version of the object for the purpose of viewing or copying.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing a request to list previous version of an object, the method comprising:
receiving, by a file system management computing device, a previous version listing request for an object, the snapshot request comprising an object path;
determining, by the file system management computing device, when the received previous version listing request includes a junction point;
resolving, by the file system management computing device, the junction point to identify a snapshot directory when the received previous version listing request is determined to include the junction point; and
providing, by the file system management computing device, a plurality of object entries present within the identified snapshot directory as previous versions of the object to a requesting client computing device.

2. The method as set forth in claim 1 wherein the resolving further comprises, resolving, by the file system management computing device, the junction point based on a stored junction table.

3. The method as set forth in claim 1 wherein the resolving further comprises, storing, by the file system management computing device, the resolved junction point.

4. The method as set forth in claim 1 further comprising, obtaining, by the file system management computing device, the plurality of object entries from the identified snapshot directory prior to the providing.

5. The method as set forth in claim 1 further comprising:
identifying, by the file system management computing device, a last component within the received objected path; and
identifying, by the file system management computing device, the snapshot directory based on the identified last component.

6. The method as set forth in claim 5 further comprising, obtaining, by the file system management computing device, the plurality of object entries based on the identified last component.

7. A non-transitory computer readable medium having stored thereon instructions for managing a request to list previous version of an object comprising executable code which when executed by a processor, causes the processor to perform steps comprising:
receiving a previous version listing request for an object, the snapshot request comprising an object path;
determining when the received previous version listing request includes a junction point;
resolving the junction point to identify a snapshot directory when the received previous version listing request is determined to include the junction point; and
providing a plurality of object entries present within the identified snapshot directory as previous versions of the object to a requesting client computing device.

8. The medium as set forth in claim 7 wherein the resolving further comprises, resolving the determined junction point based on a stored junction table.

9. The medium as set forth in claim 7 wherein the resolving further comprises, storing the resolved junction point.

10. The medium as set forth in claim 7 further comprising, obtaining the plurality of object entries from the identified snapshot directory prior to the providing.

11. The medium as set forth in claim 7 further comprising:
identifying a last component within the received objected path; and
identifying the snapshot directory based on the identified last component.

12. The medium as set forth in claim 11 further comprising, obtaining the plurality of object entries based on the identified last component.

13. A file system management computing device comprising:
a processor;
a memory, wherein the memory coupled to the processor which are configured to execute programmed instructions stored in the memory comprising:
receiving a previous version listing request for an object, the snapshot request comprising an object path;
determining when the received previous version listing request includes a junction point;
resolving the junction point to identify a snapshot directory when the received previous version listing request is determined to include the junction point; and
providing a plurality of object entries present within the identified snapshot directory as previous versions of the object to a requesting client computing device.

14. The device as set forth in claim 13 wherein the processor is further configured to execute programmed instructions stored in the memory for the resolving further comprises, resolving the determined junction point based on a stored junction table.

15. The device as set forth in claim 13 wherein the processor is further configured to execute programmed instructions stored in the memory for the resolving further comprises, storing the resolved junction point.

16. The device as set forth in claim 13 wherein the processor is further configured to execute programmed instructions stored in the memory further comprising, obtaining the plurality of object entries from the identified snapshot directory prior to the providing.

17. The device as set forth in claim 13 wherein the processor is further configured to execute programmed instructions stored in the memory further comprising:
identifying, by the file system management computing device, a last component within the received objected path; and
identifying, by the file system management computing device, the snapshot directory based on the identified last component.

18. The device as set forth in claim 17 wherein the processor is further configured to execute programmed instructions stored in the memory further comprising obtaining the plurality of object entries based on the identified last component.
